(19) United States
(12) Patent Application Publication
(10) Pub. No.: US 2018/0198299 A1
(43) Pub. Date: Jul. 12, 2018

(54) Cordless Power Tool System

(71) Applicant: William Martinen, Toronto (CA)

(72) Inventor: William Martinen, Toronto (CA)

(21) Appl. No.: 15/403,640

(22) Filed: Jan. 11, 2017

(51) Int. Cl. H02J 7/00; B25F 5/02

(52) U.S. Cl. CPC H02J 7/0045; H02J 2007/0059; B25F 5/02; H02J 7/0052

(57) ABSTRACT

A cordless power tool system for simultaneously charging a battery and powering a cordless power tool includes a cordless power tool that may be manipulated. A battery is provided and the battery is selectively electrically coupled to the cordless power tool. A charging unit is provided and the charging unit is coupled to the battery. The charging unit is in electrical communication with the battery and the charging unit is selectively electrically coupled to a power source. The charging unit selectively provides electrical power to the cordless power tool when the battery is depleted.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to power tool devices and more particularly pertains to a new power tool device for simultaneously charging a battery and powering a cordless power tool.

### BRIEF SUMMARY OF THE INVENTION

An embodiment of the disclosure meets the needs presented above by generally comprising a cordless power tool that may be manipulated. A battery is provided and the battery is selectively electrically coupled to the cordless power tool. A charging unit is provided and the charging unit is coupled to the battery. The charging unit is in electrical communication with the battery and the charging unit is selectively electrically coupled to a power source. The charging unit selectively provides electrical power to the cordless power tool when the battery is depleted.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a battery of a cordless power tool system according to an embodiment of the disclosure.

FIG. 2 is a bottom phantom view of a battery of an embodiment of the disclosure.

FIG. 3 is a perspective in-use view of an embodiment of the disclosure.

FIG. 4 is a back view of a battery of an embodiment of the disclosure.

FIG. 5 is a schematic view of an embodiment of the disclosure.

### DETAILED DESCRIPTION OF THE INVENTION

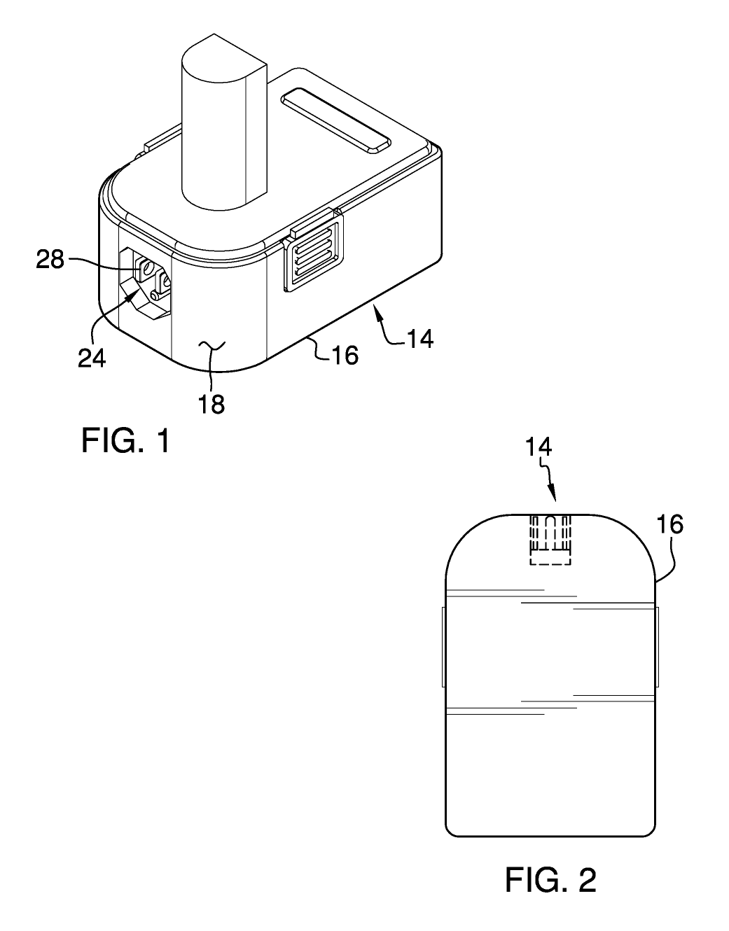

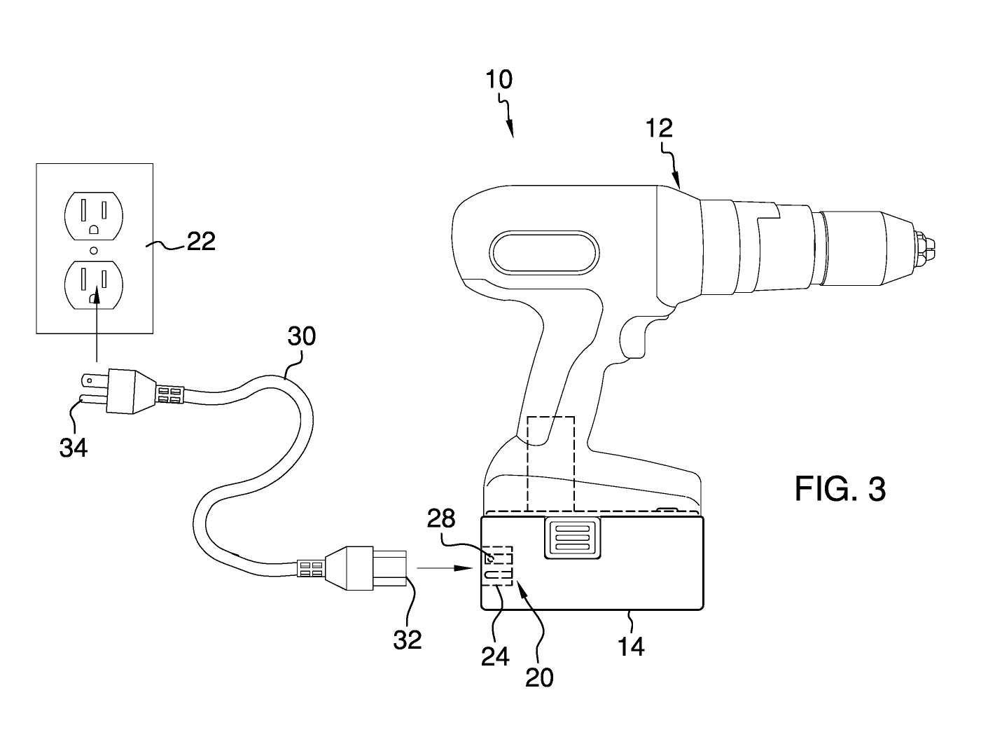

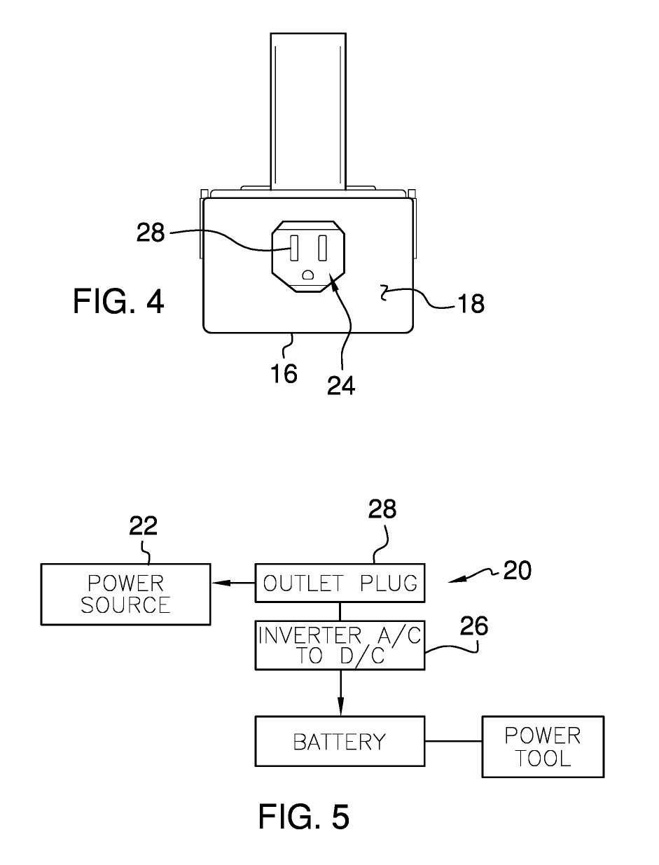

With reference now to the drawings, and in particular to FIGS. 1 through 5 thereof, a new power tool device embodying the principles and concepts of an embodiment of the disclosure and generally designated by the reference numeral 10 will be described.

As best illustrated in FIGS. 1 through 5, the cordless power tool system 10 generally comprises a cordless power tool 12 that may be manipulated. The cordless power tool 12 may be a cordless drill, a cordless saw or any other cordless power tool 12. A battery 14 is provided and the battery 14 is selectively electrically coupled to the cordless power tool 12. The battery 14 has a body 16 and the body 16 has an outer surface 18. The battery 14 may be a lithium ion battery or other rechargeable battery having an operational voltage ranging between approximately 12.0 VDC and 28.0 VDC.

A charging unit 20 is provided and the charging unit 20 is coupled to the battery 14. The charging unit 20 is in electrical communication with the battery 14 and the charging unit 20 may be electrically coupled to a power source 22. The power source 22 may be an electrical outlet or the like. The charging unit 20 selectively provides electrical power to the cordless power tool 12 when the battery 14 is depleted.

The charging unit 20 comprises a well 24 extending into the outer surface 18 of the battery 14. An inverter 26 is provided and the inverter 26 is positioned within the body 16. The inverter 26 converts alternating current to direct current and the inverter 26 is electrically coupled to the battery 14. The inverter 26 may be a solid state inverter or the like and the inverter 26 may convert 120 VAC into DC voltage ranging between approximately 12.0 VDC and 28.0 VDC.

A male plug 28 is positioned in the well 24 and the male plug 28 is electrically coupled to the inverter 26. The male plug 28 may be a three prong electrical plug or the like. A power cord 30 is provided that has a female end 32 and a male end 34. The female end 32 is selectively electrically coupled to the male plug 28 and the male end 34 is selectively electrically coupled to a power source 22. The battery 14 is charged when the power cord 30 is electrically coupled between the male plug 28 and the power source 22. Moreover, the power tool is operable when the battery 14 is charging.

In use, the power cord 30 is electrically coupled between the male plug 28 and the power source 22 when the battery 14 is depleted. The inverter 26 charges the battery 14 when the power cord 30 is coupled between the male plug 28 and the power source 22. Additionally, the inverter 26 provides electrical current to the cordless power tool 12 when the power cord 30 is coupled between the male plug 28 and the power source 22. In this way the power tool is operable while the battery 14 is being charged thereby reducing downtime associated with charging the battery 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cordless power tool system comprising:
a cordless power tool being configured to be manipulated;
a battery being selectively electrically coupled to said cordless power tool; and
a charging unit being coupled to said battery, said charging unit being in electrical communication with said battery, said charging unit being configured to be electrically coupled to a power source, said charging unit selectively providing electrical power to said cordless power tool when said battery is depleted.

2. The system according to claim 1, wherein:
said battery has a body, said body having an outer surface; and
said charging unit comprises a well extending into said outer surface of said battery.

3. The system according to claim 2, further comprising an inverter being positioned within said body, said inverter being configured to convert alternating current to direct current, said inverter being electrically coupled to said battery.

4. The system according to claim 3, wherein said charging unit comprises:
a well;
an inverter; and
a male plug being positioned in said well, said male plug being electrically coupled to said inverter.

5. The system according to claim 4, further comprising a power cord having a female end and a male end, said female end being selectively electrically coupled to said male plug, said male end being configured to be electrically coupled to a power source thereby facilitating said battery to be charged, said power tool being operable when said battery is charging.

6. A cordless power tool system comprising:
a cordless power tool being configured to be manipulated;
a battery being selectively electrically coupled to said cordless power tool, said battery having a body, said body having an outer surface; and
a charging unit being coupled to said battery, said charging unit being in electrical communication with said battery, said charging unit being configured to be electrically coupled to a power source, said charging unit selectively providing electrical power to said cordless power tool when said battery is depleted, said charging unit comprising:
a well extending into said outer surface of said battery,
an inverter being positioned within said body, said inverter being configured to convert alternating current to direct current, said inverter being electrically coupled to said battery,
a male plug being positioned in said well, said male plug being electrically coupled to said inverter, and
a power cord having a female end and a male end, said female end being selectively electrically coupled to said male plug, said male end being configured to be electrically coupled to a power source thereby facilitating said battery to be charged, said power tool being operable when said battery is charging.
